(19) United States
(12) Patent Application Publication
(10) Pub. No.: US 2026/0275060 A1
(43) Pub. Date: Sep. 17, 2026

(54) METHODS FOR POLYMER MATERIALS

(71) Applicant: QinetiQ Limited, Hampshire (GB)

(72) Inventor: Ryan Michael SEABRIGHT, Hampshire (GB)

(21) Appl. No.: 19/470,441

(22) PCT Filed: Mar. 26, 2024
(86) PCT No.: PCT/EP2024/058121

§ 371 Date: Sep. 29, 2025

(30) Foreign Application Priority Data
Mar. 30, 2023 (GB) 2305401.8

(51) Int. Cl. C08J 5/24; C08K 3/013; C08L 83/16

(52) U.S. Cl. CPC C08J 5/24; C08K 3/013; C08L 83/16; C08J 2383/16; C08L 2203/18; C08L 2205/02; C08L 2312/00

(57) ABSTRACT

A method to produce a polysilazane prepreg can include producing a resin system comprising a blend of polysilazane polymer with silazane oligomer, said oligomer acting as a reactive diluent to tune the resin system to the desired viscosity to use as a prepreg, optionally comprising fillers, said system allowing the processing of polysilazane into ceramic matrix composite parts using suitable manufacturing techniques to process standard polymer composites and to allow the manufacture of composite parts with high temperature resistance wherein the reactive diluent comprises any oligomer of lower viscosity than the polysilazane and capable of reacting with said polysilazane to form a cross linked polymer network. Also provided are composites and articles prepared according to a method in accordance with the disclosed subject matter.

In one embodiment the presently disclosed subject matter provides a method to chemically cross-link a particular polysilazane (Durazane™ 1800, Merck) using a catalyst (tetrabutylammonium fluoride, TBAF) comprising reactive F⁻ ions, which causes a number of reactions resulting in a higher molecular weight polymer material.

In one embodiment, the method of the presently disclosed subject matter is not carried out under dry inert gas and the arrangement is such that sufficient hydrogen gas is produced during the reaction so as to drive the atmosphere above the reaction liquid away, thereby providing in-situ ‘inert’ atmosphere (insofar as moisture is concerned). Also the actual extent of hydrolysis during the method of the presently disclosed subject matter does not seem to produce a particularly high concentration of siloxane (and therefore oxygen) in the final ceramic material produced. A high concentration of oxygen may be defined as an appreciable quantity of the final ceramic comprising an oxide—such as 15 mol %.

By not including a protection step, a significant bonus towards scalability is provided.

In one embodiment cross-linked material produced from Durazane™ 1800 and TBAF in THF, followed by reaction quenching with Ca(BH₄)₂·2THF to produce CaF₂ and tetrabutylammonium borohydride by-products, followed by filtration and drying under vacuum to produce a ceramic precursor.

The preparation of cross-linked material prepared by the cross-linking of a polysilazane under ambient atmospheric conditions is particularly advantageous.

In one embodiment the technique uses the inherent atmosphere generated by the synthesis for shielding and control of the synthesis time to ensure that sufficient H₂ is being evolved to expel H₂O from the reaction vessel atmosphere.

A particular benefit arises from the lack of infrastructural requirement for complex gas supply to the reaction vessel, cleaning or drying procedures for gases and solvents. Modification or additions of any form can be added to the reaction without need for complicated air-sensitive techniques to be employed that are inherently small-scale solutions in synthesis. Hence, the synthesis is yet more flexible and scalable.

Potential applications for an improved PDC precursor according to the presently disclosed subject matter include:
High temperature ceramics for aerospace applications: leading edges, exhaust ducts
High temperature resistance materials-energy materials, automotive, aerospace
Hard materials-Abrasives, bearings, cutting/machining tools
Chemical engineering-catalyst support, food- and biotechnology
Functional materials-electrical engineering, micro/nano-electronics

As such, methods and products of the presently disclosed subject matter have applications in a variety of industries including automotive, aerospace, oil and gas, and the like. The method of the presently disclosed subject matter can also be utilised in combination with other methods as appropriate.

The features of any aspect or embodiment of the presently disclosed subject matter may be used, alone or in any combination, with other aspects and embodiments as appropriate.

### BRIEF DESCRIPTION OF THE FIGURES

The presently disclosed subject matter will now be described in more detail and by way of example only, with reference to the following schematic Figures, in which:

FIG. 1 shows EDS (elemental analysis) data for a ceramic composite made from the precursor of the method of the presently disclosed subject matter.

FIG. 2 shows a round bottomed flask experimental set up.

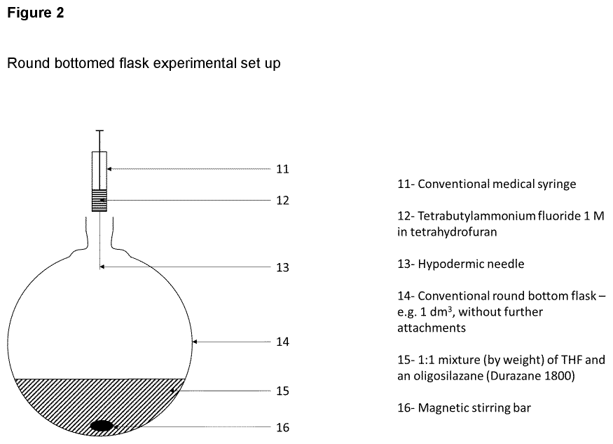

FIG. 3 shows a wide-brimmed container experimental set up.

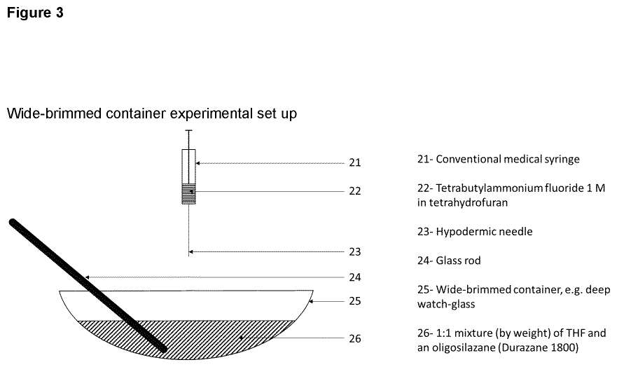

FIG. 4 shows a schematic for the fabrication of composites via traditional composite vacuum bagging with the Polysilazane prepreg.

FIG. 5 shows the oxidation resistance of a number of polymer derived ceramic matrix composite (PDCMC) samples.

FIG. 6 shows sample process for the part manufacturing using the PDC prepreg.

FIG. 7—shows Deflection vs Force results.

The presently disclosed subject matter will now be described more fully with reference to the accompanying Examples and Figures in which embodiments of the presently disclosed subject matter are shown. The claimed invention should not be construed as limited to the embodiments set forth herein.

### Example 1

400 g of an oligosilazane, Durazane™ 1800 (Merck Life Sciences, India), was added to THF (Sigma-Aldrich, Gillingham, UK) in a 1:1 mass ratio under magnetic stirring in a 3 L round bottomed flask, at room temperature. The vessel was 24.3 cm tall, 18.8 cm wide, with high curvature and a 2.5 cm neck opening diameter. No reflux condenser or gas line was added.

After homogenisation, tetrabutylammonium fluoride (TBAF) 1 M in THF (Sigma Aldrich, Gillingham, UK) was added dropwise. The rate of addition was controlled to prevent excessive evolution of H₂ gas, defined as when the entire surface was a covered by a foam, without significant disruption of the surface due to large bubbles. The total quantity of TBAF solution added was 2.3 cm³ over the course of approximately 6 hours, including time during which there was no addition due to the appearance of a full surface foam. Addition of catalyst on top of such a foam would result in over-polymerisation of the thin bubble films, resulting in insoluble scum formation. This corresponded to a final TBAF concentration of 0.00282 M, with an addition rate of 0.00038 mol h⁻¹. The final molar ratio of TBAF:oligosilazane repeat units was 0.000356.

The mixture was left to stir until gas evolution had ended. 0.1 cm³ TBAF solution was added at the end to ensure no further evolution of gas was forthcoming.

Ca(BH₄)₂·2THF (Sigma Aldrich, Gillingham, UK) was added in a 1.5:1 molar ratio with respect to F⁻ as a suspension in THF (approximately 5 cm³). The suspension was stirred for 10 minutes, and was then filtered to remove aggregates and the filtrate collected and used as synthesised in solution in compositing applications.

### Example 2

300 g of an oligosilazane, Durazane™ 1800 was treated with TBAF 1M in THF (1.7 cm³) and Ca(BH₄)₂·2THF as described in Example 1. This corresponded to a final TBAF concentration of 0.00278 M, with an addition rate of 0.00028 mol h⁻¹. The final molar ratio of TBAF:oligosilazane repeat units was 0.000351. Subsequently, the solution was concentrated in a rotary evaporator at 85° C. at pressures between 800 and 300 mBar until a pale yellow oil was obtained. This solidified on cooling to room temperature as a pale glassy solid.

### Example 3

400 g of an oligosilazane, Durazane™ 1800 was treated with TBAF and Ca(BH₄)₂·2THF as described in Example 1. This corresponded to a final TBAF concentration of 0.00282 M, with an addition rate of 0.00038 mol h⁻¹. The final molar ratio of TBAF:oligosilazane repeat units was 0.000351.

The suspension was then filtered to remove aggregates and the filtrate collected. Subsequently, the solution was concentrated in a rotary evaporator at 85° C. at pressures between 850 and 700 mBar for a total of 15 minutes until a pale yellow liquid was obtained. This contained 22 wt % retained THF solvent. This liquid was used as a viscous oil in compositing applications.

### Example 4

30 g of an oligosilazane, Durazane™ 1800 (Merck Life Sciences, India), was added to toluene (Sigma-Aldrich, Gillingham, UK) in a 1:1 mass ratio under magnetic stirring in a 0.4 L round bottomed flask with a height of 13.5 cm, a width of 10 cm and a neck opening diameter of 2.5 cm, at room temperature. No reflux condenser or gas line was added.

After homogenisation, tetrabutylammonium fluoride (TBAF) 1 M in THF (Sigma Aldrich, Gillingham, UK) was added dropwise after 2-fold dilution in toluene. The rate of addition was controlled to prevent excessive evolution of H₂ gas. The total quantity of TBAF solution added was 0.25 cm³. The mixture was left to stir until gas evolution had ended. 0.05 cm³ TBAF solution was added at the end to ensure no further evolution of gas was forthcoming. This corresponded to a final TBAF concentration of 0.00202 M, with an addition rate of 2.08×10⁻⁵ mol h⁻¹. The final molar ratio of TBAF:oligosilazane repeat units was 0.000258.

Ca(BH₄)₂·2THF (Sigma Aldrich, Gillingham, UK) was added in a 1.5:1 molar ratio with respect to F⁻ as a suspension in THF (approximately 5 cm³). The suspension was stirred for 10 minutes, and was then filtered to remove aggregates and the filtrate collected and reduced in a rotary evaporator at 85° C. and 80 mBar. A pale yellow gel was obtained at room temperature.

### Example 5

30 g of an oligosilazane, Durazane™ 1800 (Merck Life Sciences, India), was added to toluene (Sigma-Aldrich, Gillingham, UK) in a 1:1 mass ratio under magnetic stirring in a 1 L round bottomed flask, at room temperature. No reflux condenser or gas line was added.

After homogenisation, tetrabutylammonium fluoride (TBAF) 1 M in THF (Sigma Aldrich, Gillingham, UK) was added dropwise. The rate of addition was controlled to prevent excessive evolution of H₂ gas. The total quantity of TBAF solution added was 0.15 cm³. The mixture was left to stir until gas evolution had ended. 0.05 cm³ TBAF solution was added at the end to ensure no further evolution of gas was forthcoming. This corresponded to a final TBAF concentration of 0.00403 M, with an addition rate of 8.33×10⁻⁵ mol h⁻¹. The final molar ratio of TBAF:oligosilazane repeat units was 0.000516.

Ca(BH₄)₂·2THF (Sigma Aldrich, Gillingham, UK) was added in a 1.5:1 molar ratio with respect to F⁻ as a suspension in THF (approximately 5 cm³). The suspension was stirred for 10 minutes, and was then filtered to remove aggregates and the filtrate collected and reduced in a rotary evaporator at 85° C. and 80 mBar for 3 minutes. The product was collected as a viscous pale liquid at room temperature.

### Example 6

A layer of the oil of Example 3 was extruded and spread evenly on a layer of a plastic release film. A layer of Torayca COR8112 fibre was placed on this layer of oil. A coating was applied using an extruder and rolling device. Further layers of fibre and oil were sequentially applied until a total of 25 fibre plies had been laid up. A further layer of release film was placed on the top of the stack, and the stack placed between two steel plates which were spaced at 4.6 mm with spacers. The lay-up width as produced was 5 mm.

This stack was dried in an oven in ambient conditions at 160° C., and subsequently pyrolysed in Ar(g) at 1280° C. for 1 h. The sample was then tested in flexure according to ASTM C1341, and energy dispersive spectroscopy (Oxford Instruments, Oxford, UK) was performed on the matrix of the subsequently fractured ceramic composite in a scanning electron microscope (SEM).

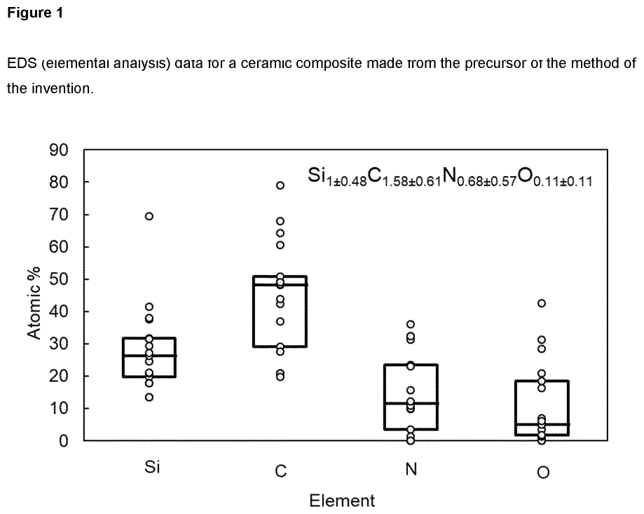

FIG. 1: The atomic percentages from a number of test sites of each of the primary constituents—Si, C, N and O. O was introduced as a contaminant variously during synthesis or pyrolysis. Overlaying the experimental data points are box-and-whisker plots displaying the median and interquartile ranges of the atomic percentage distributions for data collected across the test sites.

From FIG. 1, it is clear that there are, location dependent, large quantities of all the elements are observed. However, statistically speaking, there is a negligible quantity of oxygen across the composite at large. Relative to the abundance of silicon, the matrix has an average stoichiometry of Si_{1±0.48}C_{1.58±0.61}N^{0.68±0.57}O_{0.11±0.11}, indicating that the ceramic is predominantly a Si—C glass with some N, with statistically negligible oxygen content. While a few locations are high in oxygen, this is likely due to localised regions of oxygen enrichment, formed during strength testing or pyrolysis due to insufficiently dry inert gas supply. A wholesale hydrolysis of the precursor would manifest itself as a significant increase in the average oxygen content compared to that observed here.

Thus, it is seen that the method of the presently disclosed subject matter can produce Si—C—N ceramics with minimal oxygen content, without many of the procedural inefficiencies and large-scale inhibiting complications associated with air-sensitive chemical handling techniques.

### Example 7

6 further composite samples were produced following the method described in Example 6. The masses of these composites and the components thereof are shown in Table 1.

TABLE 1
the mass of the composites and the components thereof before and after
the pyrolysis, with the calculated ceramic yield of the precursor.

| | | |
|---|---|---|
| Green composite | Pyrolysed | |
| component mass/g | composite | Ceramic |

| Sample | Fibre | Precursor | mass/g | yield/wt % |
|---|---|---|---|---|
| 1 | 13.3 | 23.7 | 21.3 | 0.77 |
| 2 | 13.7 | 24.3 | 22.1 | 0.79 |
| 3 | 13.9 | 24.7 | 21.7 | 0.72 |
| 4 | 13.7 | 22.1 | 19.8 | 0.72 |
| 5 | 14.0 | 22.6 | 20.3 | 0.73 |
| 6 | 14.7 | 23.8 | 20.8 | 0.67 |

The average ceramic yield for the precursor was calculated to be 74±4%. The variation is likely due to lack of consistency in the gas flow and temperature in all parts of the heat treatment furnace.

### Example 8

The following Figures illustrate the benefits of preferred embodiments.

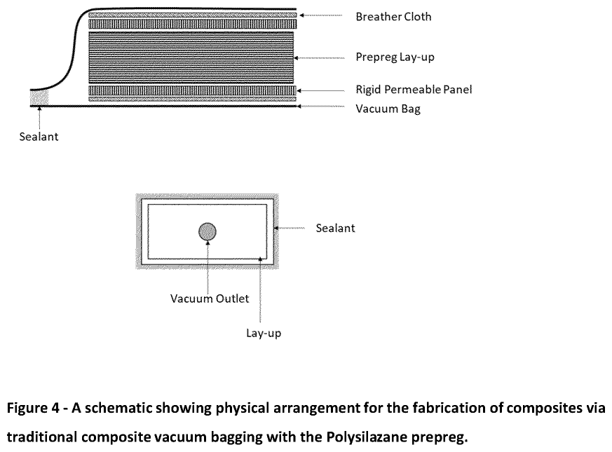

FIG. 4 schematic shows how the polysilazane prepreg could be used with a vacuum bagging process to produce a polymer derived ceramic matrix composite (PDCMC) part. As the properties of the polysilazane based resin are similar to the properties of existing polymer resins used in prepregs for the manufacture of PMC components, the process needs little to no alteration vs. existing techniques.

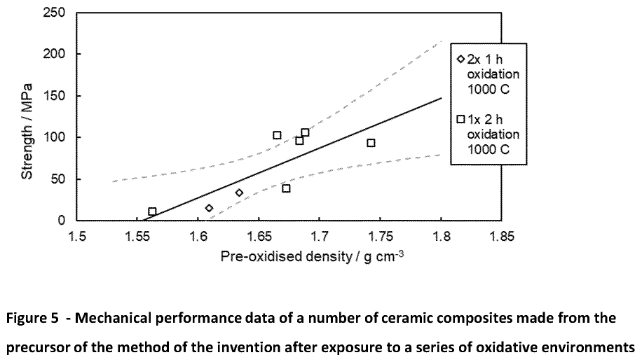

FIG. 5 shows through heat treatment of a number of test coupons at 1000° C. oxidation resilience has been demonstrated, as is shown FIG. 4. After heat treatment the coupons were testing using a 4 point bend to measure the residual strength of the coupons vs samples that were not exposed to elevated temperatures after pyrolysis.

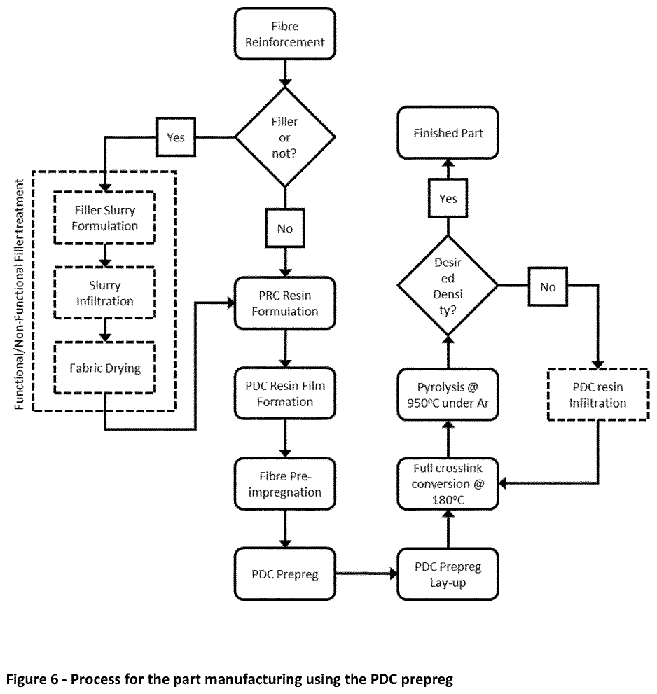

FIG. 6 shows a sample process for the part manufacturing using the PDC prepreg.

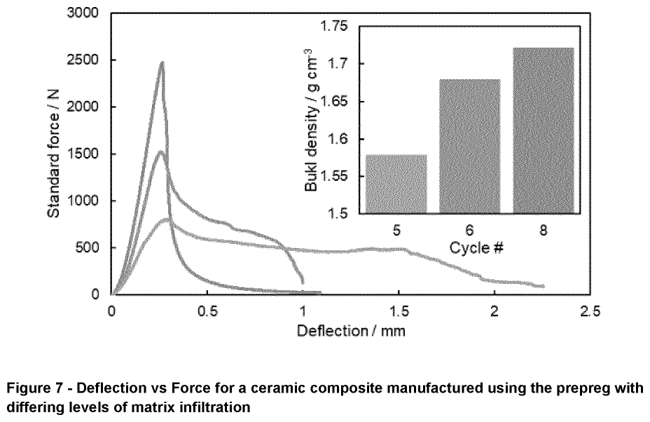

FIG. 7—Shows how the strength of the manufactured PDCMC part varies with relation to part density. It was shown that increased density results in increased strength. This relates to the process outlined in FIG. 6 as through subsequent resin infiltration, curing and pyrolysis the density of the part can be increased hence improving the mechanical properties of the part.

1. A method for producing a polysilazane prepreg comprising:
producing a resin system comprising a blend of polysilazane polymer with silazane oligomer, said oligomer acting as a reactive diluent to tune the resin system to the desired viscosity to use as a prepreg,
processing the polysilazane into ceramic matrix composite parts using suitable manufacturing techniques to process standard polymer composites and to allow the manufacture of composite parts with high temperature resistance, wherein
the reactive diluent comprises any oligomer of lower viscosity than a viscosity of the polysilazane and capable of reacting with said polysilazane to form a cross linked polymer network.

2. The method according to claim 1 further comprising preparing the polymer by cross linking under ambient conditions.

3. The method according to claim 1 wherein the oligomer viscosity is lower than 25000 cps.

4. The method according to claim 1 wherein the oligomer is oligosilazane.

5. The method according to claim 1 wherein the resin system comprises fillers selected from the group consisting of: silicon carbide, boron carbide, milled carbon fibres, alumina-silicate fibres, glass fibres, silicon carbide fibres, chopped silicon carbide fibres, chopped glass fibres, chopped alumina silicate fibres, metal fillers, (stainless steel fillers, cobalt fillers, nickel fillers), Sialon particles, magnetic oxide fillers, and stabilising fillers.

6. The method according to claim 1 wherein the high temperature resistance is greater than 800.

7. A resin system for use in the method of claim 1.

8. Composites prepared according to claim 1 having a uniform microstructure.

9. An article prepared using the method of claim 1 selected from a cost efficient panel, an exhaust pipe, a motorsport component, and a heat shield.

10. Use of polymers or composites prepared by a method of claim 1 in at least one of aerospace, automotive, oil and gas industries.

11. At least one of an exhaust pipe, a heat shield, and a rocket, prepared by a method according to claim 1.

12. Composites prepared according to claim 1 having reduced porosity

13. The method of claim 1 wherein producing a resin system includes producing a resin system with fillers.

14. The method according to claim 1, wherein the oligomer viscosity is lower than 1000 cps.

15. The method according to claim 1, wherein the high temperature resistance is greater than 1500 degrees C.

16. The method according to claim 1, wherein the high temperature resistance is about 2000 degrees C.
